(19) United States
(12) Patent Application Publication
(10) Pub. No.: US 2010/0011650 A1
(43) Pub. Date: Jan. 21, 2010

(54) Waterfowl decoy with retractable anchor and anchor line

(76) Inventor: Bryan G. Leonards, SR., Crowley, LA (US)

Correspondence Address: TED M. ANTHONY;BABINEAUX, POCHE, ANTHONY & SLAVICH, L.L.C, P.O. DRAWER 52169, LAFAYETTE, LA, 70505-2169, US

(21) Appl. No.: 12/460,214

(22) Filed: Jul. 15, 2009

Related U.S. Application Data
(60) Provisional application No. 61/134,910, filed on Jul. 15, 2008.

(51) Int. Cl. A01M 31/06

(52) U.S. Cl. 43/3

(57) ABSTRACT

A novel waterfowl decoy has a retractable anchor and accompanying anchor line. In one embodiment of the invention, an anchor line passes through a substantially hollow keel mounted at or near the base of the decoy. The line can be selectively locked in either a retracted (anchor stored) or extended (anchor deployed) position, as desired. When the anchor line is retracted, the anchor weight can be secured to the decoy keel or decoy body for convenient storage. In an alternative embodiment, the waterfowl decoy has a rotating head that can spin about an axis passing through the neck of the decoy. When the anchor is deployed, the anchor line extends from the bottom of the decoy, keel or other lower portion of said decoy. Conversely, when the anchor is not deployed, a portion of the anchor line can be spooled or wound around the neck of the decoy to remove excess slack from the anchor line.

### CROSS REFERENCES TO RELATED APPLICATION

PRIORITY OF U.S. PROVISIONAL PATENT APPLICATION Ser. No. 61/134,910 FILED Jul. 15, 2008, INCORPORATED HEREIN BY REFERENCE, IS HEREBY CLAIMED.

### STATEMENTS AS TO THE RIGHTS TO THE INVENTION MADE UNDER FEDERALLY SPONSORED RESEARCH AND DEVELOPMENT

NONE

### BACKGROUND OF THE INVENTION

1. Field of the Invention

The present invention relates to waterfowl decoys. More particularly, the present invention relates to waterfowl decoys having retractable anchors and anchor lines.

2. Brief Description of the Prior Art

Floating waterfowl decoys have long been used by hunters to lure waterfowl to desired locations. Frequently, such floating waterfowl decoys are deployed on the surfaces of bodies of water, and anchored in place to prevent such decoys from drifting out of desired positions. In most cases, such anchors comprise relatively small, dense weighting elements constructed of lead or other similar material and connected to the waterfowl decoys (usually at or near the bottom of such decoys) using strings, lines or other flexible connection means.

Existing floating waterfowl decoys give rise to a number of problems, especially during deployment, retrieval, and storage of such decoys. Anchor lines and associated anchors connected to such waterfowl decoys can frequently get tangled and/or knotted with one another. Such tangling problems are especially prevalent during storage of multiple decoys in duffle bags or other containers during periods of non-use.

In an attempt to alleviate such tangling problems, users will frequently try to wrap the flexible anchor lines around the body sections of such decoys. However, the shape and configuration of most waterfowl decoys will not promote orderly wrapping of such anchor lines. As such, said anchor lines are often subject to entanglement and knotting upon both deployment and retrieval of such decoys.

Further, prior art anchor lines are often of improper length, which results in decoys not maintaining a desired position on the surfaces of bodies of water. Various means of taking in anchor lines have been developed, but many involve complicated springs, metal components or other mechanisms that can break, corrode or rust. Other prior art decoys require users to employ additional tools or implements to reel in or put out anchor lines.

Thus, there is a need for an anchor system for use in connection with waterfowl decoys that will eliminate tangling and other problems associated with existing prior art decoy anchor systems.

### SUMMARY OF THE PRESENT INVENTION

The present invention comprises a novel waterfowl decoy having a retractable anchor and accompanying anchor line. When the decoy is deployed on the surface of a body of water, the anchor can be deployed and the anchor line can be fully or partially extended. However, when the decoy is not being used (such as when it is placed in storage) the anchor line can be retracted. The invention of the present invention can be included on newly manufactured decoys, or retro-fit onto existing/conventional waterfowl decoys.

In one embodiment of the present invention, an anchor line passes through a substantially hollow keel mounted at or near the base of a decoy. The line can be selectively locked in either a retracted (anchor stored) or extended (anchor deployed) position, as desired. When the anchor line is retracted, the anchor can be secured to the decoy keel or decoy body for convenient storage.

In another embodiment, the waterfowl decoy has a rotating head that can spin about a substantially vertical axis passing through the neck of the decoy. When the anchor is deployed, the anchor line extends from the bottom of the decoy, keel or other lower portion of said decoy. When the anchor is not deployed, a portion of the anchor line can be spooled or wound around the neck of the decoy to remove excess slack from said anchor line.

### BRIEF DESCRIPTION OF THE DRAWINGS

The foregoing summary, as well as the following detailed description of the preferred embodiments, is better understood when read in conjunction with the appended drawings. For the purpose of illustrating the invention, the drawings show certain preferred embodiments. It is understood, however, that the invention is not limited to the specific methods and devices disclosed.

FIG. 1 depicts a side view of one embodiment of the present invention with an anchor secured to a substantially hollow keel, and an anchor line retracted (and extending from the back of the keel).

FIG. 2 depicts a partially exploded view of the keel and anchor structure depicted in FIG. 1.

FIG. 3 depicts a side view of an embodiment of the present invention floating on the surface of a body of water, with an anchor deployed and the anchor line extended.

FIG. 4 depicts a front view of a waterfowl decoy of the present invention with an anchor retracted and secured within one end of the keel.

FIG. 5 depicts a side sectional view of the keel section of the invention pictured along line 5-5 of FIG. 4.

FIG. 6 depicts an alternate side sectional view of the keel section of the invention depicted in FIG. 5.

FIG. 7 depicts a side view of an alternative embodiment of the waterfowl decoy having a rotating head, with an anchor secured within one end of a keel and the anchor line retracted and partially spooled around the decoy neck.

FIG. 8 depicts a side view of the alternative embodiment of the waterfowl decoy depicted in FIG. 7, wherein the anchor is deployed and the anchor line is extended (and not spooled around the decoy neck).

FIG. 9 depicts a side sectional view of the waterfowl decoy depicted in FIG. 8.

### DETAILED DESCRIPTION OF A PREFERRED EMBODIMENT OF THE INVENTION

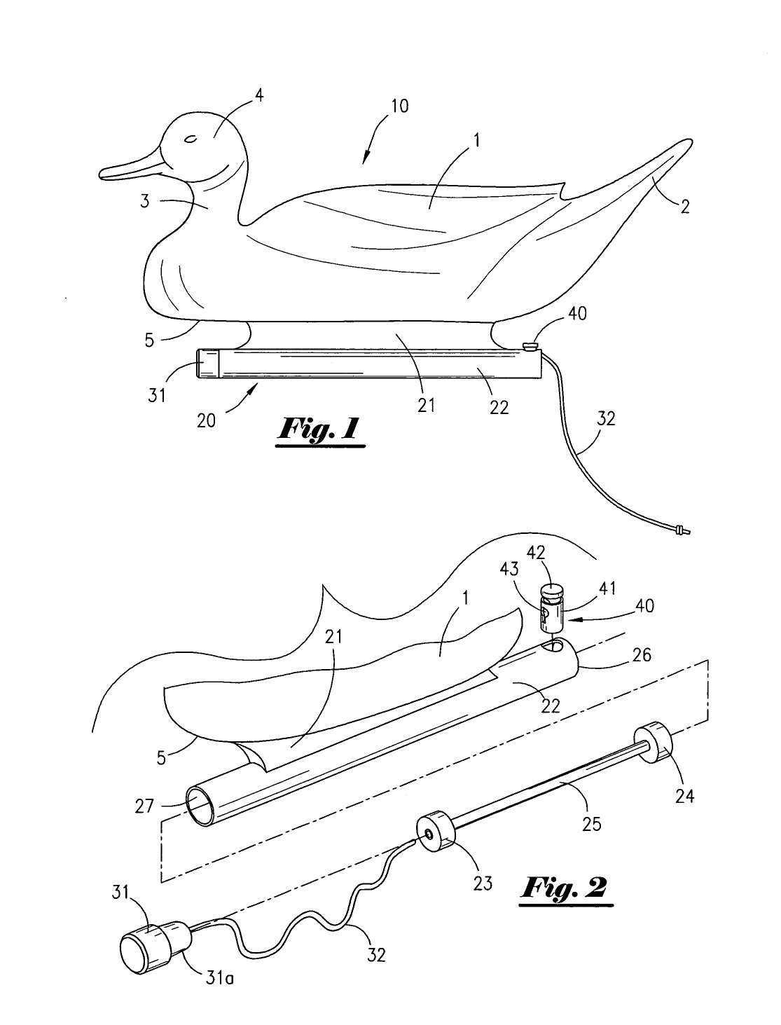

Referring to the drawings, FIG. 1 depicts a side view of one embodiment of waterfowl decoy 10 of the present invention. Waterfowl decoy 10 includes body section 1, tail section 2, neck 3, head 4 and bottom surface 5, and generally comprises a substantially hollow floating decoy simulating the appearance of a duck or other waterfowl. It is to be observed that decoy 10 of the present invention may take many different shapes, sizes and/or configurations in order to simulate the appearance of a desired waterfowl or other animal. In most cases, the precise shape, size, configuration and/or coloring of decoy 10 is be determined by the properties of the game being attracted and/or hunted.

Still referring to FIG. 1, decoy 10 further comprises keel assembly 20, which is used to provide stability and related benefits to decoy 10. In the preferred embodiment, keel assembly 20 comprises an elongate member. Specifically, in the preferred embodiment, said elongate member comprises a substantially cylindrical and substantially hollow keel member 22 having a central bore. In the preferred embodiment, fin-like extension 21 extends from bottom surface 5 of decoy 10 and connects to the upper surface of keel member 22. As depicted in FIG. 1, keel assembly 20 is oriented in a substantially horizontal direction and extends generally from the front to the rear of decoy 10. It is to be observed that keel assembly 20 (including, without limitation, fin-like extension 21 and keel member 22) may take any number of different overall configurations that incorporate substantially hollow keel member 22.

As depicted in FIG. 1, anchor 31 is partially received within one end of substantially hollow keel member 22 (in FIG. 1, the end of substantially hollow keel member facing the front of decoy 10). Anchor line 32 is connected to said anchor 31 and passes through the central bore of substantially hollow keel member 22. A portion of anchor line 32 extends out of keel member 22 at the opposite end from anchor 31. In the preferred embodiment, anchor line 32 also extends through locking assembly 40, which is itself disposed within keel member 22 near the rear of said keel member 22.

FIG. 2 depicts a partially exploded view of the keel and anchor structure of the present invention depicted in FIG. 1. Keel assembly 20 is disposed along the bottom surface 5 of decoy 10. In the preferred embodiment, fin-like extension 21 extends from bottom surface 5 of decoy 10, and connects to the upper surface of substantially cylindrical and substantially hollow keel member 22. Keel assembly 20, including fin-like extension 21 and keel member 22, extend along decoy 10, generally from the front to the rear of said decoy 10.

Substantially hollow keel member 22 has substantially cylindrical opening 27 at the front end of said hollow keel member 22, and substantially cylindrical opening 26 at the rear end of hollow keel member 22 (said opening 26 is obstructed from view in FIG. 2). Anchor line 32 is connected to anchor 31. In the preferred embodiment, anchor 31 has a generally cylindrical shape, and is constructed of lead or other dense material. Anchor 31 also has area of reduced diameter 31a. In the preferred embodiment, area of reduced diameter 31a is sized to be snuggly received within an opening, such as opening 27, of keel member 22.

In the preferred embodiment, elongate conduit tube 25 having an axially-aligned central bore extends between front grommet member 23 and rear grommet member 24. Elongate conduit tube 25, front grommet member 23 and rear grommet member 24 are received within the central bore of keel member 22. Anchor line 32 extends from anchor 31, and is threaded through front grommet member 23, elongate conduit tube 25 and rear grommet member 24. By passing through front grommet member 23, elongate conduit tube 25 and rear grommet member 24, which are all disposed within keel member 22, anchor line 32 is less likely to tangle, become knotted or bunch together within keel member 22.

In the preferred embodiment, bore 28 extends through keel member 22, and is oriented substantially perpendicular to the central bore of keel member 22. Locking assembly 40 is received within said bore 28. In the preferred embodiment, locking mechanism 40 is a “barrel style” cord lock of a type well known in the art comprising body section 41 having bore 43 disposed therethrough, and spring-biased plunger member 42 having a bore disposed therethrough. Plunger member 42 is slidably received within body section 41. Anchor line 32 is threaded through bore 43, as well as the bore of plunger member 42, and can be moved axially along the length of keel member 22 when plunger member 42 is depressed into body section 41. Conversely, anchor line 32 can be selectively locked in a desired position by allowing plunger member 42 to be biased outward to form a frictional bind on anchor line 32.

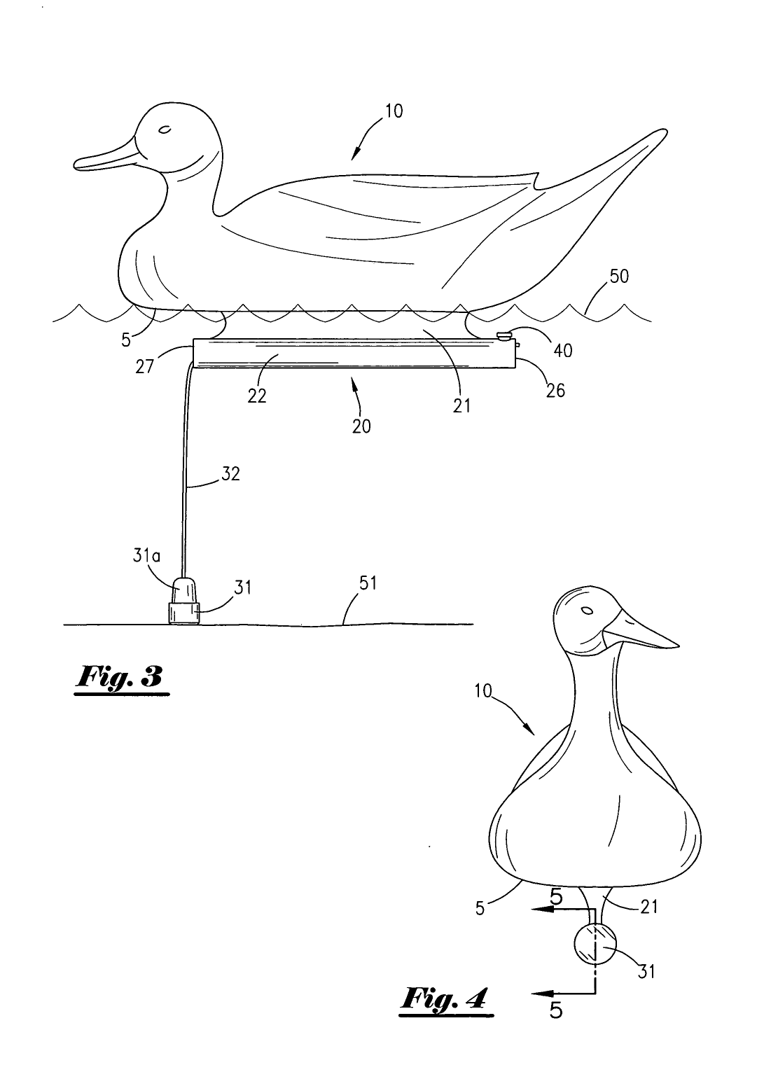

FIG. 3 depicts a side view of waterfowl decoy 10 of the present invention floating on water surface 50. Keel assembly 20 comprises substantially cylindrical and substantially hollow keel member 22 having an axially-aligned central bore. In the preferred embodiment, fin-like extension 21 extends from bottom surface 5 of decoy 10 and connects to the upper surface of keel member 22. Anchor 31 is deployed on water bottom 51, while anchor line 32 is extended and locked in place by locking mechanism 40. In this manner, waterfowl decoy 10 is secured in a substantially stationary position and desired orientation on water surface 50.

FIG. 4 depicts a front view of waterfowl decoy 10 of the present invention with anchor 31 retracted. Substantially cylindrical and substantially hollow keel assembly 20 is disposed along the bottom surface 5 of decoy 10. In the preferred embodiment, fin-like extension 21 extends from bottom surface 5 of decoy 10. As depicted in FIG. 4, anchor 31 is partially received within the forward facing end of keel member 22.

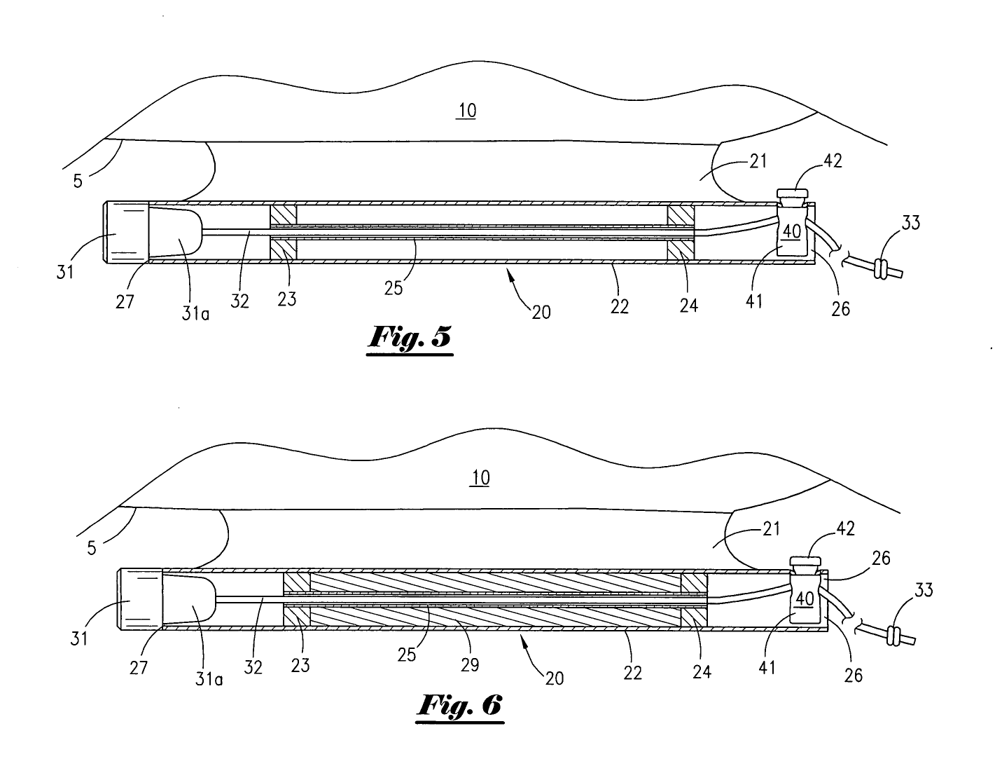

FIG. 5 depicts a side sectional view of the keel assembly 20 of the invention pictured along line 5-5 of FIG. 4. Substantially cylindrical and substantially hollow keel assembly 20 is disposed along bottom surface 5 of decoy 10. In the preferred embodiment, fin-like extension 21 extends from bottom surface 5 of decoy 10, and connects to the upper surface of keel member 22. Keel assembly 20, including fin-like extension 21 and keel housing member 22, extend lengthwise along decoy 10 generally from the front to the rear of said decoy 10.

Anchor line 32 is connected to anchor 31. In the preferred embodiment, anchor 31 has a generally cylindrical shape, and is constructed of lead or other dense material. Anchor 31 also has area of reduced diameter 31a. In the preferred embodiment, area of reduced diameter 31a is sized to be snuggly received within forward-facing opening 27 of keel member 22. If desired, the components depicted in FIG. 5 could be oriented in reverse, so that anchor 31 having area of reduced diameter 31a could be received within opening 26 of keel member 22 (facing the rear of waterfowl decoy 10), with the distal end of anchor line 32 extending out of opening 27 of keel member 22 (facing the front of waterfowl decoy 10).

In the preferred embodiment, elongate conduit tube 25 having a central bore extends between front grommet member 23 and rear grommet member 24. Elongate conduit tube 25, front grommet member 23 and rear grommet member 24 are disposed within the central bore of keel member 22. Anchor line 32 extends from anchor 31, and is threaded through front grommet member 23, elongate conduit tube 25 and rear grommet member 24. By passing through front grommet member 23, elongate conduit tube 25 and rear grommet member 24, any slack in anchor line 32 is less likely to tangle, become knotted or bunch together within keel member 22.

Anchor line 32 is threaded through bore 43 of locking mechanism 40. Anchor line 32 can be selectively locked in a desired position by releasing spring-biased plunger member 42, thereby creating a frictional bind on anchor line 32. In the preferred embodiment, knot 33 is beneficially formed near the opposite end of anchor line 32 from anchor 31.

Thus, the anchor can be partially received within the keel when the waterfowl decoy is not deployed. In this position, said anchor can be beneficially stowed during times that the waterfowl decoy is not in use or is in storage. With the anchor stowed, the flexible anchor line extends, at least partially, through said keel assembly and beneficially locks in place. Any excess anchor line that extends out of said keel assembly hangs loosely, and will not easily tangle with other waterfowl decoys or anchor lines.

When anchoring of a deployed waterfowl decoy is desired, the anchor line is unlocked—in the preferred embodiment, by depressing the plunger member of a barrel-type cord lock device. The anchor is removed from the keel, and the flexible anchor line is pulled through the keel assembly so that the anchor extends a desired length from the waterfowl decoy (frequently, this length will be determined by the depth of the water on which the decoy will be deployed). The flexible anchor line can then be locked in place while the anchor is extended and the decoy is deployed.

When removal and subsequent storage of a deployed waterfowl decoy is desired, the anchor line is unlocked—in the preferred embodiment, by depressing the plunger member of a barrel-type cord lock device. The flexible anchor line is pulled through the keel assembly so that the anchor is drawn toward the keel. If desired, the anchor can be partially received within the keel for stowing of said anchor. The flexible anchor line can then be locked in place while the anchor is stowed.

FIG. 6 depicts an alternate side sectional view of the keel assembly 20 of the invention depicted in FIG. 5. Substantially cylindrical and substantially hollow keel assembly 20 is disposed along bottom surface 5 of decoy 10. In the preferred embodiment, fin-like extension 21 extends from bottom surface 5 of decoy 10, and connects to the upper surface of keel member 22. Keel assembly 20, including fin-like extension 21 and keel housing member 22, extend generally lengthwise along decoy 10 from the front to the rear of said decoy 10.

Anchor line 32 is connected to anchor 31. In the preferred embodiment, anchor 31 has a generally cylindrical shape, and is constructed of lead or other dense material. Anchor 31 also has area of reduced diameter 31a. In the preferred embodiment, area of reduced diameter 31a is sized to be snuggly received within forward-facing opening 27 of keel member 22.

In the preferred embodiment, elongate conduit tube 25 having a central bore extends between front grommet member 23 and rear grommet member 24. Elongate conduit tube 25, front grommet member 23 and rear grommet member 24 are disposed within the central bore of keel member 22. Spacer tube 29 is disposed around elongate conduit tube 25 between front grommet member 23 and rear grommet member 24. Anchor line 32 is threaded through front grommet member 23, elongate conduit tube 25 and rear grommet member 24. By passing through front grommet member 23, elongate conduit tube 25 and rear grommet member 24, anchor line 32 is less likely to tangle, become knotted or bunch together within the central bore of keel member 22.

In the preferred embodiment, locking mechanism 40 is a “barrel style” cord lock of a type well known in the art. Anchor line 32 is threaded through bore 43. Anchor line 32 can be selectively locked in a desired position by releasing plunger member 42 and forming a frictional contact against anchor line 32. In the preferred embodiment, knot 33 is formed near the end of anchor line 32 that is opposite anchor 31.

FIG. 7 depicts a side view of an alternative embodiment of waterfowl decoy 110. Waterfowl decoy 110 includes body section 101, tail section 102, neck 103, head 104, bottom surface 105 and back 106, and generally comprises a substantially hollow floating decoy simulating the appearance of a duck or other waterfowl. It is to be observed that decoy 110 of the present invention could take any number of different shapes, sizes and/or configurations in order to simulate the appearance of a desired waterfowl or other animal. In most cases, the precise shape, size, configuration and/or coloring of decoy 110 will be determined by the specific properties of the game being attracted and/or hunted.

Alternative embodiment of waterfowl decoy 110 further comprises keel assembly 120, which is used to provide stability to decoy 110. In the preferred embodiment, keel assembly 120 comprises a substantially cylindrical and substantially hollow keel member 122 having a central bore. In the preferred embodiment, fin-like extension 121 extends from bottom surface 105 of decoy 110 and connects to the upper surface of keel member 122. Keel assembly 120 extends, generally, from the front to the rear of waterfowl decoy 110. Anchor 131 is partially received within the forward-facing open end of substantially hollow keel member 122. In the preferred embodiment, keel member 122 has closed rear-end 126.

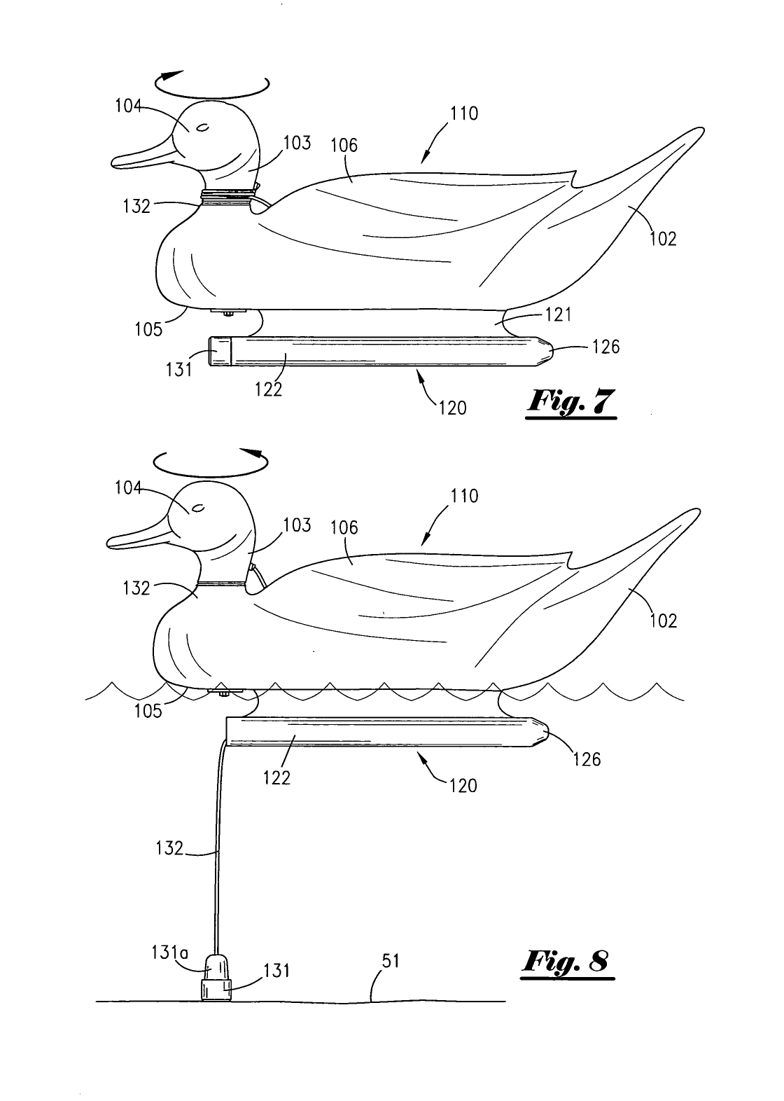

FIG. 8 depicts a side view of alternative embodiment of waterfowl decoy 110 depicted in FIG. 7, wherein waterfowl decoy 110 is depicted floating on water surface 50, with anchor 131 deployed. Anchor line 132 is extended, and anchor 31 is deployed on water bottom 51. In this manner, waterfowl decoy 110 is secured in a substantially stationary position and having a desired orientation on water surface 50.

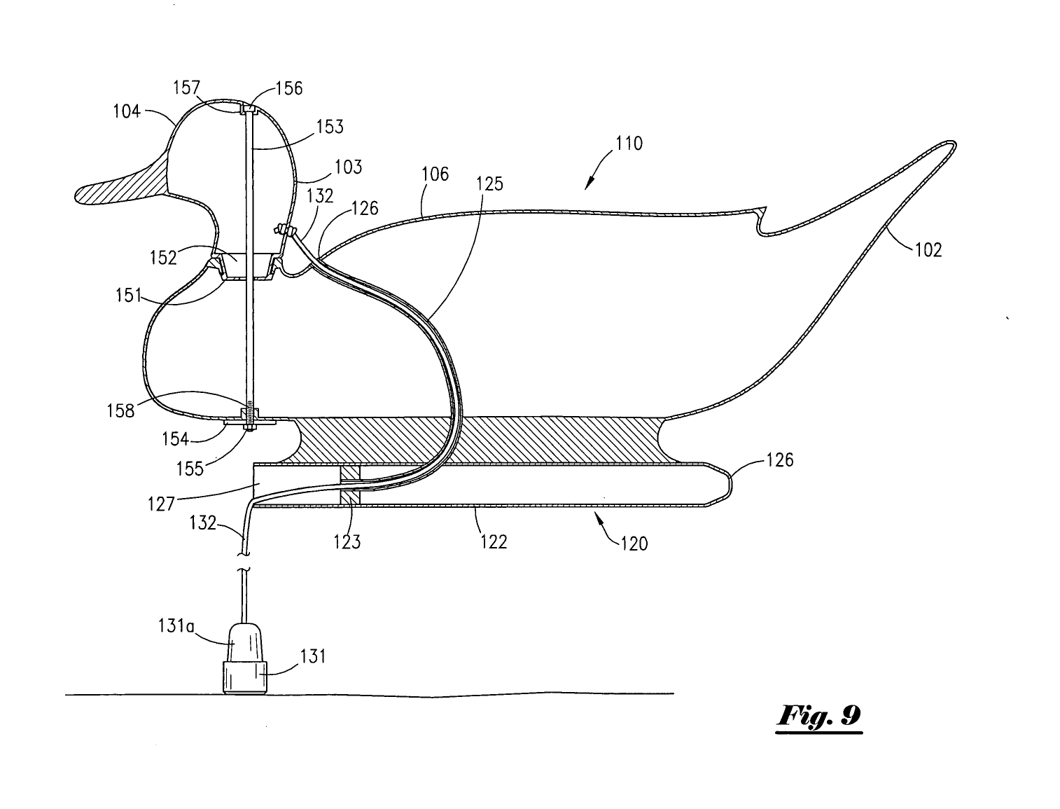

FIG. 9 depicts a side sectional view of waterfowl decoy 110 depicted in FIG. 8. Spacing grommet 123 having a central bore is disposed within keel member 122. Conduit 125 extends from grommet 123, through the body of waterfowl decoy 110, and terminates in opening 126. In the preferred embodiment, opening 126 is positioned along back section 106 of waterfowl decoy 110, in the general proximity of neck 103. Anchor line 132 extends from anchor 131 through the bore of grommet 123 and conduit 125, and is secured to head 104 of waterfowl decoy 110 (ideally at neck 103).

In the embodiment depicted in FIG. 9, head 104 has lower extension 152 that is rotatably received within recess 151. In the preferred embodiment, elongate bolt 153 having head 156 and threads 158 is disposed within waterfowl decoy 110. Bolt head 156 is beneficially received within recess 157 in head 104 of waterfowl decoy 110. Washer 154 is received on bolt 153, and nut 155 is threadedly connected to threads 158, thereby securing bolt 153 in place. Head 104 of waterfowl decoy 110 is rotatable about an axis substantially passing through elongate bolt 153.

Referring to FIG. 7, when head 104 is rotated, anchor line 132 spools around neck 103 of waterfowl decoy 110. When said waterfowl decoy 110 is in use, anchor 131 can be deployed, and anchor line 132 can be un-spooled from around neck 103 of waterfowl decoy 110. Conversely, when said waterfowl decoy 110 is not in use, such as when it is in storage between uses or deployment, head 104 can be rotated in order to spool anchor line 132 around neck 103 of waterfowl decoy 110. Anchor 131 is received within the opening 127 of keel member 122. In this manner, excess slack in anchor line 132 is gathered, and prevented from tangling or snagging on other items, such as other decoys.

Thus, when utilizing the alternate embodiment of the present invention, the anchor can be partially received within the keel when the waterfowl decoy is not deployed. In this position, said anchor can be beneficially stowed during times that the waterfowl decoy is not in use or is in storage. With the anchor stowed, the flexible anchor line extends, at least partially, through said keel assembly and the decoy body. Any excess anchor line is spooled and/or wrapped around the rotatable neck of the decoy, and will not easily tangle with other waterfowl decoys or anchor lines.

When anchoring of a deployed waterfowl decoy is desired, the anchor is removed from the keel, and the flexible anchor line is pulled through the body of the decoy and (at least a portion of) the keel assembly. As the anchor line is pulled, it becomes un-spooled from around the neck of the decoy. The anchor extends a desired length from the waterfowl decoy (frequently, this length will be determined by the depth of the water on which the decoy will be deployed).

When removal and subsequent storage of a deployed waterfowl decoy is desired, the decoy head is rotated. As the head is rotated, the flexible anchor line is pulled through the decoy body and keel assembly, and a portion of such line is spooled around the neck section of the decoy. As the anchor line is spooled around the decoy neck, the anchor is drawn toward the keel. If desired, the anchor can be partially received within the keel for stowing of said anchor.

The above-described invention has a number of particular features that should preferably be employed in combination, although each is useful separately without departure from the scope of the invention. While the preferred embodiment of the present invention is shown and described herein, it will be understood that the invention may be embodied otherwise than herein specifically illustrated or described, and that certain changes in form and arrangement of parts and the specific manner of practicing the invention may be made within the underlying idea or principles of the invention.

What is claimed:

1. A retractable anchor apparatus for a waterfowl decoy comprising:
a. a keel assembly connected to the bottom of a waterfowl decoy, wherein said keel assembly has a first end, a second end and a bore extending from said first end to said second end;
b. an anchor;
c. a flexible anchor line having a first end and a second end, wherein said first end of said flexible anchor line is connected to said anchor, and said flexible anchor line is slidably disposed through said bore of said keel assembly; and
d. a locking mechanism for preventing said anchor line from sliding within said bore of said keel assembly.

2. The retractable anchor apparatus of claim 1, wherein said anchor can be partially received within said first end of said keel assembly.

3. A retractable anchor apparatus for a waterfowl decoy comprising:
a. a keel assembly connected to the bottom of a waterfowl decoy having a front and a back, wherein said keel assembly comprises an elongate member having a first end, a second end and a central bore extending from said first end to said second end of said elongate member;
b. an anchor;
c. a flexible anchor line having a first end and a second end, wherein said first end of said flexible anchor line is connected to said anchor, and said flexible anchor line is slidably disposed through said central bore of said elongate member; and
d. a locking mechanism for preventing said anchor line from sliding within said bore of said elongate member.

4. The retractable anchor apparatus of claim 3, wherein said elongate member comprises a substantially cylindrical keel member.

5. The retractable anchor apparatus of claim 4, wherein the longitudinal axis of said substantially cylindrical keel member is oriented parallel to the longitudinal axis of said waterfowl decoy.

6. The retractable anchor apparatus of claim 5, wherein said substantially cylindrical keel member extends substantially from the front to the back of said waterfowl decoy.

7. The retractable anchor apparatus of claim 4, wherein said anchor can be partially received within said first end of said keel assembly.

8. A retractable anchor apparatus comprising:
a. a waterfowl decoy having a body and a head rotatably attached to said body;
b. a keel assembly having a first end, a second end and a bore extending through said keel assembly;
c. an anchor;
d. a flexible anchor line having a first end and a second end, wherein the first end of said flexible anchor line is connected to said rotatable head of said waterfowl decoy, the second end of said flexible anchor line is connected to said anchor, and said flexible anchor line is slidably disposed through said water fowl body and the bore of said keel assembly.

9. The retractable anchor apparatus of claim 8, wherein said anchor can be partially received within said first end of said keel assembly.

10. The retractable anchor apparatus of claim 8, further comprising a conduit extending through the body of said waterfowl decoy.

11. The retractable anchor apparatus of claim 10, wherein said flexible anchor line is slidably received within said conduit.

12. The retractable anchor apparatus of claim 8, wherein said waterfowl decoy further comprises a neck.

13. The retractable anchor apparatus of claim 12, wherein said head of said decoy rotates about an axis passing substantially through said neck.
